(19) United States
(12) Patent Application Publication
(10) Pub. No.: US 2024/0281283 A1
(43) Pub. Date: Aug. 22, 2024

(54) DATA SCHEDULING SYSTEM, RECONFIGURABLE PROCESSOR AND DATA SCHEDULING METHOD

(71) Applicant: AMICRO SEMICONDUCTOR CO., LTD., Zhuhai, Guangdong (CN)

(72) Inventors: Wang ZHAO, Zhuhai, Guangdong (CN); Dengke XU, Zhuhai, Guangdong (CN); Ziqi CHANG, Zhuhai, Guangdong (CN)

(21) Appl. No.: 18/569,236

(22) PCT Filed: Mar. 17, 2022
(86) PCT No.: PCT/CN2022/081524

§ 371 Date: Dec. 12, 2023

(30) Foreign Application Priority Data
Jun. 15, 2021 (CN) 202110659480.2

(51) Int. Cl. G06F 9/48; G06F 9/30; G06F 15/78

(52) U.S. Cl. CPC G06F 9/4881; G06F 9/30047; G06F 15/7871

(57) ABSTRACT

Disclosed in the present invention are a data scheduling system, when data to be processed is transmitted from the first FIFO to a reconfigurable array, the first write pointer control component allocates a first write cache address; when the reconfigurable array writes a processing result into the second FIFO, the second write pointer control component allocates a second write cache address; when the processing result cached in the second FIFO is read by a system bus, the read pointer control component allocates a read cache address; the empty-state determination control component determines an empty-state of the second FIFO according to the second write cache address and the read cache address; and the full-state determination control component determines a full-state of the second FIFO according to the first write cache address and the read cache address.

### CROSS-REFERENCE TO RELATED APPLICATIONS

The present disclosure takes the Chinese Patent Application No. 2021106594802, filed on Jun. 15, 2021, and entitled “data scheduling system, reconfigurable processor and data scheduling method”.

### TECHNICAL FIELD

The disclosure relates to the field of integrated circuits, in particular to a data scheduling system for reconfigurable computing, reconfigurable processor and data scheduling method.

### BACKGROUND

With the rapid rise of artificial intelligence, big data, cloud computing, 5G communication and other applications, it brings more intensive data and more intensive computing, which poses a challenge to the chip computing power. Coarse-grained reconfigurable processor architectures are gaining increasing attention for their low energy consumption, high performance, and high energy efficiency and flexible dynamic refactoring. Coarse-grained reconfigurable computing architecture is a high performance computing architecture that combines the flexibility of general processors and dedicated integrated circuits, which is very suitable for very high parallel applications such as data and computation-intensive.

In a coarse-grained reconfigurable architecture, a reconfigurable array includes fully functional computational units such as adders, subtractors, multipliers, dividers, square root extractors, trigonometric calculators, etc. In order to ensure the high clock frequency and calculation efficiency of the reconfigurable processor, most of these calculations adopt streamline design. Due to the different calculation complexity to be realized, the calculation flow depth of different calculation units is often different. After the computing units of different flow depths in the reconfigurable array are reconstructed into different computing paths, the overall data processing of the reconfigurable array should still be guaranteed, so as to give full play to the computing performance of the reconfigurable processor.

According to different application requirements, the reconfigurable array can flexibly change its own computing unit pathway structure, so that the total flow depth of the reconfigurable array can be reconfigured, which can also be dynamically adjusted according to different applications. Under the premise that the reconfigurable array dynamically adjusts the flow depth, after the computational processing of the reconfigurable array, the data of one or more frames output by the reconfigurable array may be easily lost in memory because there is not enough cache space.

### SUMMARY

The disclosure provides a data scheduling system, a reconfigurable processor and a data scheduling method. The specific technical solution is as follows:

A data scheduling system, the data scheduling system is configured to transmit data with a reconfigurable array, and the data scheduling system is configured to also transmit data with a system bus; the data scheduling system includes a first FIFO, a first write pointer control component, a second FIFO, a second write pointer control component, a read pointer control component, an empty-state determination control component and a full-state determination control component; a first write pointer control component is configured to allocate a first write cache address to a processing result within the second FIFO by means of increasing an address pointer, when data to be processed is transmitted from the first FIFO to the reconfigurable array; wherein, the processing result is a result obtained by the reconfigurable array when the data to be processed is processed by the reconfigurable array, and the processing result is output by the reconfigurable array; a second write pointer control component is configured to allocate a second write cache address within the second FIFO to a processing result currently output by the reconfigurable array by the means of increasing the address pointer, when the reconfigurable array writes the processing result into the second FIFO; a read pointer control component is configured to allocate a read cache address to a processing result to be read within the second FIFO by means of increasing the address pointer, when the processing result of a cache in the second FIFO is read by the system bus; a empty-state determination control component is configured to determine an empty-state of the second FIFO according to an address value relationship between the second write cache address and the read cache address, and triggers the read pointer control component to control the second FIFO from being read data by the system bus when the second FIFO is determined to be in the empty-state, so as to control the second FIFO not being read empty; a full-state determination control component is configured to determine a full-state of the second FIFO according to an address value relationship between the first write cache address and the read cache address, and triggers the first write pointer control component to control the first FIFO not to write data to be processed to the reconfigurable array when the second FIFO is determined to be in the full-state, so as to control the second FIFO from overflow.

A reconfigurable processor, wherein, integrates the reconfigurable array and the data scheduling system.

A data scheduling method, data transmission with a reconfigurable array is arranged by means of a data scheduling system, and data transmission with a bus system is arranged by means of a data scheduling system; wherein the data scheduling system includes a first FIFO and a second FIFO; The data scheduling method includes: Step A, when data to be processed is transmitted from the first FIFO to the reconfigurable array, allocating the first write cache address within the second FIFO to a processing result, then controlling the first write cache address to be increased by one and to be updated; wherein the processing result is a result obtained by the reconfigurable array when the data to be processed is processed by the reconfigurable array, and the processing result is output by the reconfigurable array; Step B, when the second FIFO receives a processing result currently output by the reconfigurable array, allocating the second write cache address within the second FIFO to the processing result currently output by the reconfigurable array, then controlling the second write cache address to be increased by one and being updated; Step C, when the processing result of a cache in the second FIFO is read by the system bus, allocating a read cache address to a processing result to be read within the second FIFO, then controlling the read cache address to be increased by one and to be updated; Step D, determining an empty-state of the second FIFO according to an address value relationship between the second write cache address and the read cache address, and when the second FIFO is in an empty-state, controlling the second FIFO from being read data by the system bus, so as to control the second FIFO not being read empty; Step E, determining a full-state of the second FIFO according to an address value relationship between the first write cache address and the read cache address, and when the second FIFO is in the full-state, controlling the first FIFO not to write data to be processed to the reconfigurable array, so that the second FIFO does not overflow.

### BRIEF DESCRIPTION OF THE DRAWINGS

FIG. 1 is a schematic diagram of a data scheduling system disclosed in an embodiment of the disclosure.

FIG. 2 is a flowchart of a data scheduling method as disclosed in another embodiment of the disclosure.

### DETAILED DESCRIPTION OF THE EMBODIMENTS

The embodiment of the disclosure will be described in detail below with reference to the accompanying drawings. It should be noted by those skilled in the art that all components disclosed in the following embodiment are logic circuits. A logic circuit can be a physical unit, can also be a state machine composed of a number of logic devices according to certain reading timing and writing timing and signal logic changes, can also be a part of a physical unit, but also can be a combination of multiple physical units. Moreover, in order to highlight the innovative part of the disclosure, the embodiment of the disclosure is not closely related to solving the technical problems of the disclosure, but this does not mean that no other unit exists in the embodiment of the disclosure.

FIFO is a memory device widely used in the field of integrated circuits. The usual FIFO memory consists of a write control component, a read control component and a FIFO memory component. FIFO works as follows: read/write data from/to the memory component with a read pointer and a write pointer under the control of the read pulse and write pulse. The read pointer and the write pointers are independent of each other. The read pointer and the write pointer each start from a first address unit, read/write to the last address unit in order, and then return to the first address unit. By comparing the read pointer and the write pointer, the judgment of the empty state and the full state of the memory component is obtained. FIFO Overflow (Overrun) is caused by the large difference in the speed of reading and writing, and the attempt to write new data when FIFO is already filled up. For the overflow of FIFO, the usual method is to discard new data and write the overflow (Overrun) flag to the corresponding position of the write address, and the write address is not increased. The disadvantage of this method is that this may cause data loss and some performance waste. The overflow of FIFO is due to one port used for the data reading fails to read away the data in FIFO in time, for example, when the read pointer points to the address 0x3, a new external data H new request to write into FIFO, due to the read pointer and the write pointer each point to the address 0x3, so data overflow phenomenon occurs, according to processing methods disclosed in the prior art, the data H will be abandoned, meanwhile, the overflow flag bit of the data corresponding to the address 0x3 is set as valid, that is, the overflow flag bit of data C in the address 0x3 is set as 1. In the following data reading process, the data to be read first starts from the address 0x3 pointed by the read pointer, meanwhile, the read control component will find that the overflow flag bit of data C is valid, and the processing methods disclosed in the prior art will discard invalid data from a byte to the end of a frame data. But the fact that the frame of data is actually intact, in this case, the processing methods disclosed in the prior art is a waste of efficiency.

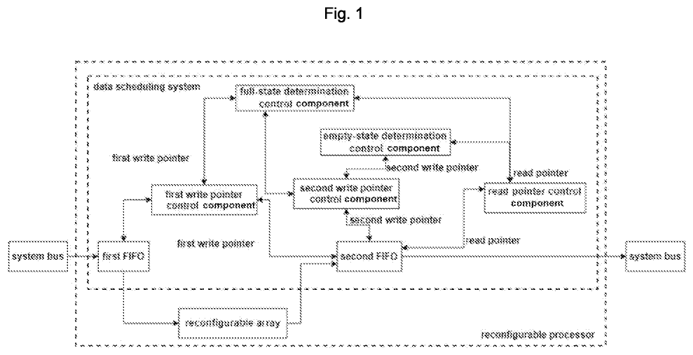

As shown in FIG. 1, one embodiment of the present disclosure discloses a schematic diagram of a data scheduling system. The data scheduling system includes a first FIFO, a first write pointer control component, a second FIFO, a second write pointer control component, a read pointer control component, an empty-state determination control component and a full-state determination control component. As shown in FIG. 1, the data scheduling system is configured to transmit data with a reconfigurable array, and the data scheduling system is configured to also transmit data with a system bus. The first FIFO is configured as a receiving FIFO. The receiving FIFO is configured to receive data transmitted by the system bus and cache data transmitted by the system bus. The first FIFO is also configured to be connection to a special write control component and a read control component, not indicated in FIG. 1; the reconfigurable array can be regarded as a cascade computing unit with dynamically adjustable flow depth, forming a multi-level pipeline reconfigurable array, which can be integrated with a data scheduling system into a reconfigurable processor. In this embodiment, the second FIFO is configured as a transmitting FIFO, which is a cache of the data sent to the system bus. The second FIFO is configured with a first write pointer control component, a second write pointer control component and a read pointer control component, that is, a FIFO memory component is connected with two write control components and one read control component, wherein, the first write pointer control component is associated with the second FIFO and the first FIFO presence write command respectively. The second write pointer control component and the read pointer control component are each dedicated control components for the second FIFO. The full-state determination control component has a command interaction relationship with the first write pointer control component and the read pointer control component respectively. The empty-state determination control component has a command interaction relationship with the second write pointer control component and the read pointer control component respectively; in some implementation scenarios, the second FIFO, the second write pointer control component, the read pointer control component, the empty-state determination control component and the full-state determination control component are integrated in a memory. The second FIFO, the second write pointer control component, the read pointer control component, the empty-state determination control component and the full-state determination control component establish an electrical connection with the first FIFO and the reconfigurable array.

It is understandable by those skilled in the art based on the prior art that if the reconfigurable array obtains data to be processed from the system bus, the system bus first stores data to be processed in the first FIFO, then the data to be processed is processed by the reconfigurable array to the second FIFO, and finally, the system bus reads data output by the reconfigurable array by means of the second FIFO. To ensure a formation of the data throughput of the reconfigurable array, if the first FIFO is not empty and the second FIFO has residual cache space, the read data from the first FIFO (the receiving FIFO) is transmitted to the reconfigurable array for processing. Since the reconfigurable array is a multi-stage flow structure with dynamic change of the pipeline depth, the data transmitted to the reconfigurable array cannot be immediately written to the second FIFO, and a time delay of flow depth L is generated during transmission. Specifically, the reconfigurable array reads the data to be processed written by the first FIFO at time T1, and after a time delay of the flow depth, a processing result of the reconfigurable array which is used for processing the data to be processed can be transmitted to the second FIFO at time T2, wherein T2 is greater than T1. In some embodiments, data processed in a reconfigurable array (assuming M (M=<L)) is transmitted to the second FIFO one by one after a time delay of calculating the flow depth L. In conclusion, if it starts to determine whether the second FIFO has enough space to cache the data transmitted by the reconfigurable array in sequence or not at time T2. It is possible that time T2 comes earlier than expected due to a change of flow depth L, resulting in data overflow of the second FIFO which does not have enough space.

It should be noted that in the application scenario of data transmission for the reconfigurable array of multi-stage flow, in order to ensure data is correctly written or read out correctly to avoid overflow or FIFO being read empty, FIFO cannot write in the full-state and read in the empty-state. Obviously, when the FIFO is in the full-state, a new data can not be written, otherwise it will cause data overflow; when the FIFO is in the empty-state, if a previously written data has been read, the previously written data can not be read, otherwise the previously written data is configured as an invalid data.

In order to overcome the above problems, as shown in FIG. 1, based on the first FIFO (as a receiving FIFO for the data scheduling system) and the second FIFO (as a transmitting FIFO for the data scheduling system), the first write pointer control component, the second write pointer control component, the read pointer control component, the empty-state determination control component, and the full-state determination control component, especially the first write pointer control component is added relative to the prior art.

In the embodiment of the disclosure, a first write pointer control component is configured to allocate a first write cache address to a processing result within the second FIFO by means of increasing an address pointer, when data to be processed is transmitted from the first FIFO to the reconfigurable array, that is, whenever the first FIFO writes data to be processed to the reconfigurable array. Wherein, the processing result is a result obtained by the reconfigurable array when the data to be processed is processed by the reconfigurable array, and the processing result is output by the reconfigurable array. The first write cache address corresponds to the address pointer. The address pointer is a pointer indicating the address of the data cache to be written within the second FIFO. When the address pointer is automatically increased by one, an address to which the address pointer points is automatically increased by one, so as to plan the writable address space range for the processing result of the corresponding output of the reconfigurable array. Specifically, means of increasing an address pointer performed by the first write pointer control component includes: under the control of the corresponding enable signal, when the data to be processed starts to be transmitted to the reconfigurable array from the first FIFO, the first write pointer control component is configured to output a first write pointer, and then a next write address to which the first write pointer points within the second FIFO is configured to be the first write cache address.

For the first write pointer control component, after the data to be processed is completely transmitted from the first FIFO to the reconfigurable array, the first write pointer control component is configured to control the first write pointer to be increased by one, then the first write pointer is updated to the first write pointer increased by one, then, when the next data to be processed starts to be transmitted to the reconfigurable array from the first FIFO, a next write address to which the updated first write pointer points within the second FIFO is updated to the first write cache address, and the next data to be processed is updated to the data to be processed, with above iterative update, that is, after each time the next data to be processed is completely transmitted from the first FIFO to the reconfigurable array, the next data to be processed corresponds to the first write cache address prior to each update, the first write cache address before each update may be a cache address within the second FIFO as the processing result obtained by the reconfigurable array processing of the next data to be processed. The first write pointer control component continues to control the first write pointer to be increased by one, until all the data to be processed is sequentially transmitted from the first FIFO to the reconfigurable array or until the first FIFO is in the empty-state; It should be added that, in this embodiment, when the first FIFO isn't in the empty-state and the empty-state indication signal is not marked on the corresponding flag bit of the first FIFO, the first write pointer may traverse from the first address unit of the second FIFO, sequentially through to its last address unit; and then the first write pointer returns to the first address unit.

In this embodiment, before a result obtained by the reconfigurable array processing is transmitted to the second FIFO (that is before the processing result is transmitted to the second FIFO), the first write pointer has been increased by one in advance, reserving the address space for writing data in the second FIFO. Therefore, compared with the prior art, a first write pointer can be increased in advance in the second FIFO, so that the address information corresponding to the writing data can be reserved in the second FIFO when the data to be processed is processed by the reconfigurable array but not written to the second FIFO. Therefore, the second FIFO determines the address information corresponding to the full-state before it is fully filled, so as to avoid the overflow in the process of the dynamic change of the pipeline depth within the reconfigurable array, and ensure a formation of the data throughput rate of the reconfigurable array whose flow depth is dynamically adjusted.

In an embodiment of the disclosure, the second write pointer control component is configured to allocate a second write cache address within the second FIFO to a processing result currently output by the reconfigurable array by means of increasing an address pointer, when the reconfigurable array writes the processing result into the second FIFO; wherein, the second write cache address corresponds to the write address pointer corresponding to the second FIFO. The write address pointer is a write pointer indicating the address of the data cache to be written within the second FIFO. When the write address pointer is automatically increased by one, an address to which the write address pointer points is automatically increased by one, so that the write cache address allocated to the processing result currently obtained by the reconfigurable array (that is, the processing result currently output by the reconfigurable array) is increased by one within the second FIFO. Specifically, means of increasing an address pointer performed by the second write pointer control component includes: under the control of the corresponding write enable signal, when the reconfigurable array starts writing a processing result of a current output into the second FIFO, that is, the processing results currently output by the reconfigurable array starts to be written into the second FIFO, the second write pointer control component is configured to output a second write pointer, and then a next write address to which the second write pointer (belonging to the write address pointer) points within the second FIFO is configured to be the second write cache address.

For the second write pointer control component, after the processing result of the current output by the reconfigurable array is completely written into the second FIFO, that is, after the reconfigurable array completely writes the processing results of the current output to the second FIFO, the second write pointer control component is configured to control the second write pointer to be increased by one, then the second write pointer is updated to the second write pointer increased by one, then, when the reconfigurable array starts writing a processing result of a next output into the second FIFO, a next write address to which the updated second write pointer points within the second FIFO is updated to the second write cache address, and the processing result of the current output is updated to the processing result of the next output, and the second write cache address before updating is the write cache address of the processing result of the next output in the second FIFO; and the processing result of the current output is updated to the processing result of the next output. With above iterative update, the second write pointer control component continues to control the second write pointer to be increased by one, until the second FIFO is in the full-state; It should be added that, in this embodiment, when the first FIFO isn't in the empty-state and the empty-state indication signal is not marked on the corresponding flag bit of the first FIFO, the first write pointer may traverse from the first address unit of the second FIFO, sequentially through to its last address unit; and then the first write pointer returns to the first address unit. It should be added that, if the second FIFO does not mark a full-state indication signal, the second write pointer may begin traversing from the first address unit of the second FIFO, sequentially through to its last address unit; and then the second write pointer returns to the first address unit.

Based on the aforementioned embodiment, by setting the second write pointer corresponding to the second FIFO, indicating a cache address required for the processing result output by the reconfigurable array within the second FIFO. For a batch of data to be processed, the time from which the second write pointer is incrementally pointing to the last target cache address in the second FIFO is later than the time from which the first write pointer is incrementally pointing to the last target cache address in the second FIFO, whether the delay time corresponding to the flow depth of the reconfigurable array becomes longer or shorter. Thus, when the same batch of data is transmitted and processed by the reconfigurable array, the first write pointer is always moved to the last address space within the second FIFO earlier than the second write pointer, and the first write pointer triggers a write full signal earlier than the second write pointer, so that the second write pointer is only configured to judge the empty-state of the second FIFO in this embodiment.

In the embodiment of the disclosure, the read pointer control component is configured to allocate a read cache address to a processing result to be read within the second FIFO by means of increasing the address pointer, when the processing result of a cache in the second FIFO is read by the system bus, that is, the second FIFO starts transmitting the processing result currently to be sent to the system bus; the read cache address corresponds to the read address pointer corresponding to the second FIFO. The read address pointer is a read pointer indicating the address of the data cache to be read within the second FIFO. When the read address pointer is automatically increased by one, an address to which the read address pointer points is automatically increased by one, so that the read cache address allocated to the processing result currently transmitted by the second FIFO (that is, the processing result currently output by the reconfigurable array) is increased by one, and the read cache address is configured to be read by the system bus. Specifically, means of increasing an address pointer performed by the read pointer control component includes: under the control of the corresponding read enable signal, when the system bus starts reading a processing result (a processing result currently to be transmitted) of the cache in the second FIFO, that is, the second FIFO starts to transmit the processing result to the system bus, the read pointer control component is configured to output a read pointer (i. e., the read address pointer), and then a next read address to which the read pointer points within the second FIFO is configured to be the read cache address.

For the read pointer control component, after a current transmission processing result of the cache in the second FIFO is completely read by the system bus, that is, after the processing result currently to be sent is transmitted completely to the system bus by the second FIFO, the read pointer control component is configured to control the read pointer to be increased by one, then the read pointer is updated to the read pointer increased by one, and when a next processing result of the cache in the second FIFO starts to be read by the system bus, that is, the next processing result to be sent of the cache in the second FIFO starts to be read by the system bus, a next read address to which the updated read pointer points within the second FIFO is updated to the read cache address, at this moment, the read cache address before the update is the read cache address of the next processing result, that is, the storage address of the next processing result to be sent within the second FIFO; and the next processing result is updated to the current transmission processing result, wherein, the current transmission processing result is the processing result of the current output or the processing result of the current output by the reconfigurable array; with above iterative update, the read pointer control component continues to control the read pointer to be increased by one, until the second FIFO is in the empty-state. It should be added that, when the second FIFO does not mark an empty-state indication signal, the second write pointer may start traversing from the first address unit of the second FIFO, sequentially through to its last address unit; and then the second write pointer returns to the first address unit. Wherein, the processing result of the current output by the reconfigurable array is the current transmission processing result.

The reading pointer disclosed in this embodiment is configured to point to the next read address, and be automatically increased by one after reading. Combined with the aforementioned embodiments, in the process of the read pointer reading out the cached data in the second FIFO, if the read pointer catches up with the first write pointer or the read pointer is tracked by the first write pointer, a read-empty signal triggering the second FIFO takes effect, so as to prevent the data read by the system bus from being invalid data.

Based on the aforementioned embodiment, the present disclosure also discloses an empty-state determination control component. The empty-state determination control component is configured to determine an empty-state of the second FIFO according to an address value relationship between the second write cache address and the read cache address, and triggers the read pointer control component to control the second FIFO from being read data by the system bus when the second FIFO is determined to be in the empty-state, that is, the system bus stops reading the data from the second FIFO, so as to control the second FIFO not being read empty. In the embodiment, the empty-state determination control component is configured to determine the second FIFO is in the empty-state when it is determined that the second write cache address is the same as the read cache address, that is, when the second write pointer outputted by the second write pointer control component is equal to the read pointer outputted by the read pointer control component, a read-empty flag bit set in the corresponding storage space in the second FIFO is valid, and it is determined that the second FIFO is in the empty-state. Thus, during the read operation and write operation in the second FIFO, it is determined that whether the second FIFO becomes in an empty-state or not in real time, so as to avoid that the second FIFO is emptied by the system bus, and avoid affecting the transmission correctness of the bus data flow. An address value relationship between the second write cache address and the read cache address is actually obtained in this embodiment by judging whether the corresponding binary address of the second write cache address is the same as the corresponding binary address of the read cache address or not.

Based on the aforementioned embodiment, a full-state determination control component is configured to determine a full-state of the second FIFO according to an address value relationship between the first write cache address and the read cache address, and triggers the first write pointer control component to control the first FIFO not to write data to be processed to the reconfigurable array when the second FIFO is determined to be in the full-state, so as to control the second FIFO from overflow, at the same time, in some implementation scenarios, the processing result is written into the second FIFO from the reconfigurable array. Specifically, the full-state determination control component is configured to determine that the second FIFO is in the full-state when it is determined that the highest bit of the first write cache address is different from the highest bit of the read cache address and the remaining bits except the highest bit in the first write cache address are equal to the remaining bits except the highest bit in the read cache address; wherein, the address value is a binary number; the first write cache address, the second write cache address and the read cache address are each represented by binary addresses. When the MSB of the address to which the first write pointer points (the highest bit of the first write cache address) is not equal to the MSB of the address to which the read pointer points (the highest bit of the read cache address), and the remaining bits of the address to which the first write pointer is equal to the remaining bits of the address indicated by the read pointer, the full-state indication signal marked by the second FIFO is set to be valid (can be set to 1), such that the second FIFO is determined to be in the full-state in advance at the stage when the data to be processed is written to the reconfigurable array by the first FIFO. The full-state determination control component determines whether the second FIFO is in the full-state or not by controlling the first write cache address (the first write pointer is incrementally refreshed) to repeat traversing the second FIFO once again to catch up with the read cache address (the read pointer is incrementally refreshed), the address space for writing data can be reserved in the second FIFO when the data to be processed is written to the reconfigurable array but the processing result is not written to the second FIFO, so as to control the second FIFO from overflow.

To sum up, the aforementioned embodiment, in a stage when the data is written into a reconfigurable array but has not yet been processed or transmitted to the second FIFO, allocating the first write cache address by means of increasing the address pointer with the timing of data transmission from the first FIFO to the reconfigurable array. According to the address value relationship between the read cache address and the first write cache address, determining whether the second FIFO has enough space as the send FIFO to cache the data transmitted by the reconfigurable array or not, so as to define the address range filled fully with data to be written by the reconfigurable array in the second FIFO in advance, and adapt to the flow depth generated by the dynamic change of the reconfigurable array pipeline. It is not necessary to determine whether the second FIFO has sufficient data cache space or not when the reconfigurable array transmits data to the second FIFO, and control the second FIFO to mark a full-state signal before being fully filled, effectively prevent the second FIFO from overflow during the dynamic change of the pipeline depth within the reconfigurable array. On the other hand, according to the numerical relationship between the read cache address that changes incrementally when the data is transmitted from the second FIFO to the system bus and the second write cache address that changes incrementally when the reconfigurable array writes the data to the second FIFO, it determines whether the second FIFO becomes empty in the process of reading the data by the system bus or not, and grasps the data cache situation of the second FIFO in time. Therefore, the present disclosure utilizes the increment control of the two write cache addresses and one read cache address during data read operation and data write operation, to ensure that the processing result can be written into the second FIFO and transmitted to an external system bus by the second FIFO under reasonable storage conditions, after the data to be processed is transmitted to the reconfigurable array and processed by the dynamically changed flow depth; and the correctness and efficiency of the data flow transmission control of the multistage flow reconfigurable array is ensured, so as to improve the throughput characteristics of the reconfigurable arrays.

As one embodiment, the first write pointer control component and the second write pointer control component are each implemented by counters; the first write pointer control component and the second write pointer control component each output the count value as a write pointer, wherein the count value output by the first write pointer control component can be configured as the first write pointer (that is the address value corresponding to the first write cache address), and the count value output by the second write pointer control component may be configured as the second write pointer (that is the address value corresponding to the second write cache address). There is a power relationship of 2 between a bit width of the counter and a depth of the second FIFO, in this embodiment, the depth of the second FIFO is equal to: taking the difference between the bit width of the counter and 1 as the exponential and the power of the base 2, wherein, the difference between the bit width of the counter and 1 is the value obtained from the bit width of the counter minus 1; so that a write pointer output by the first write pointer control component and a write pointer output by the second write pointer control component each point to any cache address within the second FIFO, in particular, the traversal of the cache address within the second FIFO is completed in an automatic incrementing manner, the counter drives the increasing change of the write pointer by counting and is able to traverse the cache address within the second FIFO, such that the write pointer can change incrementally to change the highest bit of the address to which the write pointer points, at this moment, the highest bit of an address to which the write pointer points is set to a fold back flag bit for indicating whether the write pointer is incremented and over the last cache address of the second FIFO or not, so as to represent the full-state of the second FIFO; wherein an address bit width corresponding to the write pointer is equal to the bit width of the counter, and the address bit width corresponding to the write pointer is a sum value obtained by adding one to an address bit width of the second FIFO. In this embodiment, the highest bit of the address to which the write pointer points is set to a fold back flag bit indicating whether the write pointer is incremented and over the last cache address of the second FIFO or not. The reason for the highest bit of the address to which the write pointer points (the binary bit of the pointer to the left of the address) is set to the fold back flag bit is that for the hardware, the highest bit of the binary address is likely to be determined, which improves the efficiency of the hardware execution.

As an embodiment, the read pointer control component is implemented by a counter; the read pointer control component outputs their count value as a read pointer, and there is a power relationship of 2 between a bit width of the counter and a depth of the second FIFO, that is, the depth of the second FIFO is equal to 2 \hat{ }(the value obtained from the bit width of the counter minus 1), so that a read pointer output by the read pointer control component point to any cache address within the second FIFO; wherein an address bit width corresponding to the read pointer is equal to the bit width of the counter, the counter drives the increasing change of the read pointer by counting and is able to traverse the cache address within the second FIFO, such that the read pointer can change incrementally to change the highest bit of the address to which the read pointer points, at this moment, the highest bit of an address to which the read pointer points is set to a fold back flag bit for indicating whether the read pointer is incremented and over the last cache address of the second FIFO or not, so as to represent the empty-state of the second FIFO. The reason for the highest bit of the address to which the read pointer points (the binary bit of the pointer to the left of the address) is set to the fold back flag bit is that for the hardware, the highest bit of the binary address is likely to be determined, which improves the efficiency of the hardware execution.

The full-state determination control component determines that the MSB of the first write pointer is different from the MSB of the read pointer, it is determined that the first write pointer is turned back once more than the read pointer, and the remaining bits except the highest bit in the first write pointer are equal to the remaining bits except the highest bit in the read pointer, for example, read pointer r_addr [3:0]=0000, and the first write pointer w_addr [3:0]=1000, wherein, r_addr[3]=0, w_addr[3]=1, therefore the highest bit corresponding to r_addr is a binary 0, the highest bit corresponding to r_addr is not equal to the highest bit corresponding to w_addr (binary 1), then the full-state determination control component determines that the second FIFO is in the full-state. The empty-state determination control component determines that the MSB of the second write pointer is equal to the MSB of the read pointer, it is determined that the times of turn back of the second write pointer is equal to that of the read pointer, and the remaining bits except the highest bit in the first write pointer are equal to the remaining bits except the highest bit in the read pointer, then the empty-state determination control component determines that the second FIFO is in the empty-state. In some embodiments, the full-state determination control component and the empty-state determination control component are combined into one component, so as to complete the determination of empty-state and full-state. When the second FIFO is in the empty-state, the second FIFO is controlled not to be read by the system bus; when the second FIFO is in the full-state, the data to be processed is controlled not to be written in the reconfigurable array from the first FIFO. Since the first write pointer has reserved an address space in the second FIFO allowing to write data, so, as long as the reconfigurable array does not continue to receive a new data to be processed, the reconfigurable array processes data to be processed existing inside and outputs corresponding processing results to the second FIFO, but not causing an overflow of the second FIFO. If the second FIFO is determined to be in the empty-state, the first FIFO does not write the data to be processed into the reconfigurable array, so as to ensure that the data written to the reconfigurable array is valid.

As an embodiment, the reconfigurable array includes at least two levels cascade of computing array; the computing array of the adjacent two levels is connected as a pipeline structure that meets computing power requirements of an algorithm matching current application scenarios, by using a reconfiguration information generated by an external software configuration; wherein each level pipeline of the pipeline structure corresponds to a level computing array, and each level of the computing array include at least one computing unit; a delay time corresponding to the flow depth is a time consumed to data flow through the corresponding data path within the pipeline structure. Within a reconfigurable array, there are at least two hierarchical arrangements of the computing array, that is, at least two computing array cascade connections, at least two adjacent computing arrays, or at least two adjacent levels, wherein only one computing array is provided on each column of a reconfigurable array, one computing array is a level computing array; the number of computing arrays within this reconfigurable array is predetermined in the reconfigurable array. The above computing arrays are cascaded in structures present in the reconfigurable arrays. The following is the corresponding description of the pipeline, all using one level of computing array to describe one column of computing array, so as to facilitate the subsequent interconnection architecture of the reconfigurable array on the hardware. It is important to emphasize that within the current level computing array, only the computing component connected to the data pathway is considered as a current level pipeline of the pipeline structure, the number of cascades of computing arrays or the number of computing arrays is predetermined in the reconfigurable array. The computing array is a hardware resource pre-existing in the reconfigurable array. And the pipeline structure is configured by the interconnection logic between the adjacent computing array based on existing computing arrays according to reconstruction information. In the reconfigurable array, the computing array of adjacent two levels is connected through the way of two adjacent interconnection (equivalent to the two interconnect) to form the pipeline structure to meet computing requirements of the algorithm. When the reconfiguration information changes, the computing requirements of the corresponding execution algorithm also change accordingly, and the computing array of adjacent columns is re-connected based on the changed reconfiguration information, so as to realize the algorithm of matching the current application scenario in the form of hardware circuit. At the same time, the flow depth of the pipeline structure connected by the adjacent two levels is automatically adjusted, that is, the flow depth of the pipeline structure can change, so that the flow depth of the pipeline structure changes automatically with the change of the reconfiguration information.

Actually for current data processing application scenarios, the reconfigurable array receives the external reconfiguration information used to change the interconnection logic of the computing component (including the combination parameters and timing parameters of the logic circuit). The reconfigurable array then changes the physical architecture of the connection of multiple computing components based on the reconfiguration information, and then the reconfigurable array output the processing results, equivalent to the software programming calling algorithm (algorithm library function) in the current data processing application scenario to calculate the corresponding processing results. For different application requirements, when the reconfigurable array changes from one configuration to another, reconfigurable array can be connected to match the computational structure according to different application requirements. Thus, it can not only face several algorithms in a specific domain, but also receive reconfiguration information transplanted into algorithms in other fields.

In the embodiment, the output of the first FIFO is connected to a matching input of the reconfigurable array, the reconfigurable array is configured to receive the data to be processed from the first FIFO and transmit the data to be processed to a computing array on the pipeline structure for computing processing. The input of the second FIFO is connected to a matching output of the reconfigurable array for a computing output of the pipeline structure transmitted to the second FIFO according to the reconstructed information, wherein the computing output is the processing result. Compared with the prior art, the reconfigurable array is based on a computing component for performing the adjacent interconnections of the computing instructions, refactoring the data pathway pipeline structure with the same depth of the computing array and meeting the computing requirements of the algorithm, so that the reconfigurable array to configure the adapted flow depth according to different algorithms, on this basis, together with an externally connected data scheduling system, realizing the overall flow of data processing operations of reconfigurable arrays, and improving the throughput rate of the reconfigurable arrays, and maximizing the computational performance of the reconfigurable arrays. It also reduces the hardware resources required for the pipeline design of prior technologies.

Therefore, the time taken by the first write pointer control component to write the data to be processed to the reconfigurable array to the reconfigurable array to write the processing result to the second FIFO, is equal to the delay time corresponding to the flow depth of the reconfigurable array, so that, under the control action of the full-state determination control component, regardless of how the flow depth of the pipeline structure formed by the interconnection within the reconfigurable array changes, the first write pointer points to the address to be written in the second FIFO for the data to be processed before the second write pointer points to the same address to be written for the processing result of the data to be processed, that is, the first write pointer points earlier than the second write pointer to the same address, wherein, the time interval where the first write pointer and the second write pointer successively point to the same address to be written is equal to the delay time corresponding to the flow depth of the reconfigurable array. Compared with the prior art, a first write pointer can be increased in advance in the second FIFO, so that the address information corresponding to the writing data can be reserved in the second FIFO when the data to be processed is processed by the reconfigurable array but not written to the second FIFO. Thus, the second FIFO determines the address information corresponding to the full-state before being fully filled, so as to avoid the overflow in the process of the dynamic change of the pipeline depth within the reconfigurable array, and ensure a formation of the data throughput rate of the reconfigurable array whose flow depth is dynamically adjusted, so as to define the address range filled with data to be written by the reconfigurable array in the second FIFO in advance, and adapt to the flow depth generated by the dynamic change of the reconfigurable array pipeline, and ensure a formation of the data throughput rate of the reconfigurable array whose flow depth is dynamically adjusted.

As one embodiment, the first FIFO is configured to successively receive the data to be processed from the system bus, and then store the data to be processed, and export successively the data to be processed to the reconfigurable array; when the first FIFO outputs data to be processed to the reconfigurable array, that is, the first FIFO writes the processed data into the reconfigurable array, the first FIFO feeds back to the first write pointer control component to control the first write pointer to be increased by one, so as to control the first write pointer to automatically point to adjacent cache addresses to be written in sequence within the second FIFO. The second FIFO is configured to successively receive the processing result from the reconfigurable array, and then store the processing result, and export successively the processing result to the system bus; when the second FIFO outputs a processing result to the system bus, that is, each time the second FIFO receives a processing result from the reconfigurable array, the second FIFO feeds back to the second write pointer control component to control the second write pointer to be increased by one, so as to control the second write pointer to point to adjacent new cache addresses to be written within the second FIFO. It should be noted that the second FIFO and the first FIFO are each set to synchronous FIFO so as to facilitate the control of the read pointer and the write pointer. A first FIFO group is set as the cache of the reconfigurable array. A first FIFO group is configured to transmit data from the system bus. A second FIFO group is set as the cache of the data output from the reconfigurable array to the system bus. With the first write pointer and the read pointer are set in the above embodiment, the data scheduling system obtains the amount of data configured to make the second FIFO being in the full-state in advance, wherein the data is transmitted from the first FIFO to the reconfigurable array. Thus the data throughput rate of the reconfigurable array and external system elements and the data transmission efficiency of the system bus are ensured, so as to fully exert the operation performance of the reconfigurable array.

It should be noted that the aforementioned pointer control component, state determination control component and FIFO can be but not limited to a digital circuit component compiled by the designer using the hardware description language Verilog HDL, or a circuit drawing or compilation component formed by the designer on the software with circuit drawing or compilation function. Further, each functional unit in various embodiments of the disclosure may be integrated in one processing component, each unit may exist physically independently, or two or more units may be integrated in one component.

Based on the aforementioned embodiments, the present disclosure also discloses a reconfigurable processor, the reconfigurable processor integrating the reconfigurable array and the data scheduling system. Within the reconfigurable processor, the data scheduling system combines an efficient data scheduling and prediction system based on the two pre-set write pointers and a pre-set read pointer, so as to avoid overflow or being read empty of the FIFO that is configured to transmit the processing result of the reconfigurable array to the system bus; and the reconfigurable processor ensures a formation of the data throughput rate of the reconfigurable array that has dynamically adjustable flow depth, so as to improve the correctness and efficiency of a reconfigurable computing data flow control.

The present disclosure also discloses a data scheduling method; data transmission with a reconfigurable array is arranged by means of a data scheduling system, and data transmission with a bus system is arranged by means of a data scheduling system; wherein the data scheduling system includes a first FIFO and a second FIFO; wherein, the data scheduling system includes a first FIFO and a second FIFO. The first FIFO has a connection with a corresponding read control component and a write control component, the second FIFO is configured to be connected to a first write pointer control component, a second write pointer control component and a read pointer control component. The data scheduling system determines the full-state of the second FIFO by using the cache address value corresponding to the first write pointer output by the first write pointer control component and the cache address value corresponding to the read pointer output by the read pointer control component. On the other hand, the data scheduling system completes the determination of the empty-state of the second FIFO by using the cache address value corresponding to the second write pointer output by the second write pointer control component and the cache address value corresponding to the read pointer output by the second write pointer control component.

The data scheduling method includes:

Step A, when data to be processed is transmitted from the first FIFO to the reconfigurable array, allocating a first write cache address within the second FIFO to a processing result, then controlling the first write cache address to be increased by one and to be updated; wherein the processing result is a result obtained by the reconfigurable array when the data to be processed is processed by the reconfigurable array, and the processing result is output by the reconfigurable array. Implement that when data to be processed is transmitted from the first FIFO to the reconfigurable array, a first write pointer control component is configured to allocate a first write cache address to the processing result within the second FIFO in advance by means of increasing an address pointer.

The address pointer in step A is a pointer indicating the data cache address to be written in the second FIFO, corresponding to a first write cache address. When data to be processed is transmitted from the first FIFO to the reconfigurable array but the data to be processed has not been processed by the reconfigurable array, the address pointer is automatically increased by one, the first write cache address allocated is also automatically increased by one, so as to plan the writable address space range for the processing result of the corresponding output of the reconfigurable array.

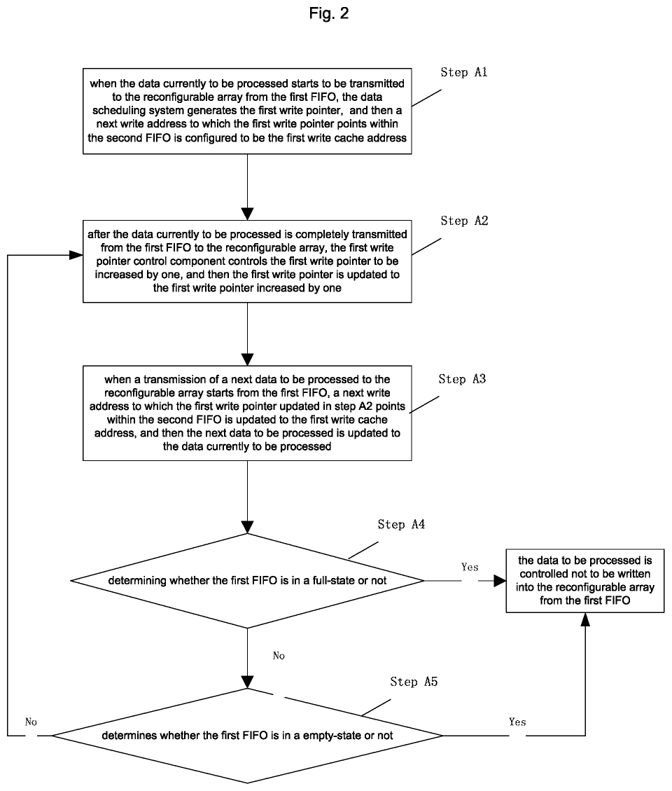

As shown in FIG. 2, the specific method of step A includes:

Step A1, when the data to be processed starts to be transmitted to the reconfigurable array from the first FIFO (possibly executed under the control of the corresponding enable signal), the data scheduling system generates the first write pointer, specifically the first write pointer control component generates the first write pointer, and then a next write address to which the first write pointer points within the second FIFO is configured to be the first write cache address; then step A2 is executed.

Step A2, after the data to be processed is completely transmitted from the first FIFO to the reconfigurable array, the first write pointer control component controls the first write pointer to be increased by one, and then the first write pointer is updated to the first write pointer increased by one, and the binary address value to which the updated first write pointer points is one larger than the binary address value to which the pre-update first write pointer point; then step A3 is executed.

Step A3, when a transmission of a next data to be processed to the reconfigurable array starts from the first FIFO, a next write address to which the first write pointer updated in step A2 points within the second FIFO is updated to the first write cache address, and then the next data to be processed is updated to the data to be processed; then step A4 is executed. Wherein, the pre-update first write cache address is the write cache address of the processing result of the next output in the second FIFO.

Step A4, determining whether the first FIFO is in a full-state or not; if the first FIFO is in the full-state, the data to be processed is controlled not to be written into the reconfigurable array from the first FIFO; if the first FIFO is not in the full-state, step A5 is executed; in this embodiment, since the first write pointer has reserved an address space in the second FIFO allowing to write data, so, as long as the reconfigurable array does not continue to receive a new data to be processed, the reconfigurable array processes data to be processed existing inside and outputs corresponding processing results to the second FIFO, but not causing an overflow of the second FIFO.

Step A5, determines whether the first FIFO is in a empty-state or not; if the first FIFO is in the empty-state, it is determined that the data to be processed is not cached in the first FIFO, and the data to be processed is controlled not to be written into the reconfigurable array from the first FIFO; if the first FIFO is not in the empty-state, step A2 is executed. The first write pointer control component continues to control the first write pointer to be increased by one. And step A2, step A3 and step A4 are executed iteratively until the first FIFO is in the empty-state or the second FIFO is in the full-state, so that the first write pointer has been increased by one before the processing result is transmitted to the second FIFO to reserve the address space for writing data in the second FIFO.

It should be added that in the above embodiment, when the first FIFO is not in the empty-state, and the empty-state indication signal is not marked on the corresponding flag bit of the first FIFO, the first write pointer may traverse from the first address unit of the second FIFO, sequentially through to its last address unit; and then the first write pointer returns to the first address unit.

Compared with the prior art, a first write pointer can be added in advance, so that the address information corresponding to the writing data can be reserved in the second FIFO when the data to be processed is processed by the reconfigurable array but not written to the second FIFO. Therefore, the second FIFO determines the address information corresponding to the full-state before it is fully filled, so as to avoid the overflow in the process of the dynamic change of the pipeline depth within the reconfigurable array, and ensure a formation of the data throughput rate of the reconfigurable array whose flow depth is dynamically adjusted.

Step B, when the second FIFO receives a processing result currently output by the reconfigurable array, allocating the second write cache address within the second FIFO to the processing result currently output by the reconfigurable array, then controlling the second write cache address to be increased by one and being updated; when the second FIFO receives a processing result output by the reconfigurable array, a second write pointer control component is configured to allocate a second write cache address within the second FIFO to a processing result currently output by the reconfigurable array by means of increasing an address pointer. Wherein, the second write cache address corresponds to the write address pointer corresponding to the second FIFO. The write address pointer is a write pointer indicating the address of the data cache to be written within the second FIFO. When the write address pointer is automatically increased by one, an address to which the write address pointer points is automatically increased by one, so that the write cache address allocated to the processing result currently obtained by the reconfigurable array is increased by one within the second FIFO, that is, the processing result of the current output of the reconfigurable array corresponding to the cache address to be written in the second FIFO is offset by the numerical value of the binary 1.

Specifically, the specific method of the step B includes:

Step B1, the reconfigurable array starts writing a processing result of a current output into the second FIFO, the second write pointer is generated by the second write pointer control component, and then the second write pointer control component controls a next write address to which the second write pointer points within the second FIFO to be the second write cache address; and then step B2 is executed by the second write pointer control component.

Step B2, after the processing result of the current output by the reconfigurable array is completely written into the second FIFO, the second write pointer control component controls the second write pointer to be increased by one, and then the second write pointer control component updates the second write pointer increased by one to the second write pointer, then step B3 is executed by the second write pointer control component.

Step B3, when the reconfigurable array starts writing a processing result of a next output into the second FIFO, that is, when the second FIFO starts receiving the processing result of the next output of the reconfigurable array, the second write pointer control component updates a next write address to the second write cache address, wherein, a next write address is pointed to which the second write pointer updated in step B2 within the second FIFO. At this moment, the second write cache address before updating is the write cache address of the processing result of the next output in the second FIFO; and then the processing result of the current output is updated to the processing result of the next output. And then step B2 is executed by the second write pointer control component, so step B2 and step B3 are executed iteratively until the reconfigurable array does not output processing results or there is no data to be processed within the reconfigurable array.

The execution of step B1 to step B3 indicates a cache address required for the processing result output by the reconfigurable array within the second FIFO by setting the second write pointer corresponding to the second FIFO. For a batch of data to be processed, the time from which the second write pointer is incrementally pointing to the last target cache address in the second FIFO is later than the time from which the first write pointer is incrementally pointing to the last target cache address in the second FIFO, whether the delay time corresponding to the flow depth of the reconfigurable array becomes longer or shorter. Thus, when the same batch of data is transmitted and processed by the reconfigurable array, the first write pointer is always moved to the last address space within the second FIFO earlier than the second write pointer, and the first write pointer triggers a write full signal earlier than the second write pointer, so that the second write pointer is only configured to judge the empty-state of the second FIFO in this embodiment; and reserving cache space in the second FIFO combined with the first write pointer, so as to prevent the second FIFO from being fully filled when the second write pointer is in the traversal process.

It should be added that if the second FIFO does not mark the full-state indication signal, the second write pointer may begin traversing from the first address unit of the second FIFO, sequentially through to its last address unit; and then the second write pointer returns to the first address unit.

Step C, when the processing result of a cache in the second FIFO is read by the system bus, allocating a read cache address to a processing result to be read within the second FIFO, then controlling the read cache address to be increased by one and to be updated; So that a second write pointer control component is configured to allocate a second write cache address within the second FIFO to a processing result currently output by the reconfigurable array by means of increasing an address pointer, when the reconfigurable array writes the processing result into the second FIFO. Wherein, the read cache address corresponds to the read address pointer corresponding to the second FIFO. The read address pointer is a read pointer indicating the address of the data cache to be read within the second FIFO, when the read address pointer is automatically increased by one, an address to which the read address pointer points is automatically increased by one, so that the read cache address allocated to the processing result currently transmitted by the second FIFO is increased by one, and the read cache address is configured to be read by the system bus.

Specifically, the method of the step C includes:

Step C1, when a processing result of the cache in the second FIFO is read by the system bus, that is, whenever the processing result to be sent is transmitted from the second FIFO to the system bus, a read pointer is generated by the read pointer control component; and then a next read address to which the read pointer points within the second FIFO is configured to be the read cache address, under the control of the read pointer control component; and then step C2 is executed by the read pointer control component.

Step C2, when a processing result (the processing result to be sent currently) of the cache in the second FIFO is completely read by the system bus, the read pointer control component controls the read pointer to be increased by one, and then the read pointer control component updates the read pointer increased by one to the read pointer, then the step C3 is executed by the read pointer control component.

Step C3, when a next processing result of the cache in the second FIFO starts to be read by the system bus, that is, when the system bus starts to read the next processing result to be sent of an internal cache of the second FIFO, a next read address to which the updated read pointer points within the second FIFO is updated to the read cache address by the read pointer control component; at this moment, the read cache address before the update is the read cache address of the next processing result, that is, the storage address of the next processing result to be sent within the second FIFO; and the next processing result is updated to the current transmission processing result (the next processing result to be sent is updated to the current transmission processing result to be sent), then the read pointer control component returns to step C2; then the step C2 and the step C3 are executed iteratively, so that the read pointer control component controls the read pointer to be increased by one, until the second FIFO is in the empty-state. It should be added that when the second FIFO does not mark an empty-state indication signal, the read pointer may start traversing from the first address unit of the second FIFO, sequentially through to its last address unit, and then the second write pointer returns to the first address unit.

The read pointer disclosed in the step C1 to the step C3 is configured to point to the next read address, and be automatically increased by one after reading. Combined with the aforementioned embodiments, in the process of the read pointer reading out the cached data in the second FIFO, if the read pointer catches up with the first write pointer or the read pointer is tracked by the first write pointer, a read-empty signal triggering the second FIFO takes effect, so as to prevent the data read by the system bus from being invalid data.

Step D, determining an empty-state of the second FIFO according to an address value relationship between the second write cache address and the read cache address, and when the second FIFO is in an empty-state, controlling the second FIFO from being read data by the system bus, so as to control the second FIFO not being read empty. Specifically, when it is determined that the second write cache address is the same as the read cache address, the second FIFO is in the empty-state, that is, when the second write pointer outputted by the second write pointer control component is equal to the read pointer outputted by the read pointer control component, a read-empty flag bit set in the corresponding storage space in the second FIFO is valid, and it is determined that the second FIFO is in the empty-state. Thus, during the read operation and write operation in the second FIFO, it is determined that whether the second FIFO becomes in the empty-state or not in real time, so as to avoid that the second FIFO is emptied by the system bus, and avoid affecting the transmission correctness of the bus data flow. An address value relationship between the second write cache address and the read cache address is actually obtained in this embodiment by judging whether the corresponding binary address of the second write cache address is the same as the corresponding binary address of the read cache address or not.

Step E, determining a full-state of the second FIFO according to an address value relationship between the first write cache address and the read cache address, and when the second FIFO is in the full-state, controlling the first FIFO not to write data to be processed to the reconfigurable array, so that the second FIFO does not overflow. Specifically, when it is determined that the highest bit address value of the first write cache address is different from the highest bit of the read cache address, and the remaining bits except the highest bit in the first write cache address are equal to the remaining bits except the highest bit in the read cache address, the second FIFO is in the full-state; wherein, the address value is a binary number; when the MSB of the address to which the first write pointer points (the highest bit of the first write cache address) is not equal to the MSB of the address to which the read pointer points (the highest bit of the read cache address), and the remaining bits of the address to which the first write pointer is equal to the remaining bits of the address indicated by the read pointer, the full-state indication signal marked by the second FIFO is set to be valid (can be set to 1), such that the second FIFO is determined to be in the full-state in advance at the stage when the data to be processed is written to the reconfigurable array by the first FIFO. The step E determines whether the second FIFO is in the full-state or not by controlling the first write cache address (the first write pointer is incrementally refreshed) to repeat traversing the second FIFO once again to catch up with the read cache address (the read pointer is incrementally refreshed), the address space for writing data can be reserved in the second FIFO when the data to be processed is written to the reconfigurable array but the processing result is not written to the second FIFO, so as to control the second FIFO from overflow.

Compared with the prior art, the aforementioned steps A to E at the stage when the data is written into a reconfigurable array but has not yet been processed or transmitted to the second FIFO, the first write cache address is allocated in advance by means of increasing the address pointer with the timing of data transmission from the first FIFO to the reconfigurable array. According to the address value relationship between the read cache address and the first write cache address, determining whether the second FIFO has enough space as a send FIFO to cache the data transmitted by the reconfigurable array or not, so as to define the address range filled fully with data to be written by the reconfigurable array in the second FIFO in advance, and adapt to the flow depth generated by the dynamic change of the reconfigurable array pipeline, effectively preventing the second FIFO from overflow during the dynamic change of the pipeline depth within the reconfigurable array. Based on the numerical relationship between the read cache address that changes incrementally when the data is transmitted from the second FIFO to the system bus and the second write cache address that changes incrementally when the reconfigurable array writes the data to the second FIFO, it determines whether the second FIFO becomes empty in the process of reading the data by the system bus or not, and grasps the data cache situation of the second FIFO in time. In conclusion, the present embodiment completes the full-state determination and the empty-state determination of the second FIFO by using the two write cache addresses and one read cache address during data read operation and data write operation, so as to ensure that the processing result can be written into the second FIFO and transmitted to an external system bus by the second FIFO under reasonable storage conditions, after the data to be processed is transmitted to the reconfigurable array and processed by the dynamically changed flow depth. And the correctness and efficiency of the data flow transmission control of the multistage flow reconfigurable array is ensured such that the data throughput rate of the reconfigurable arrays is improved.

It should be noted that the first write cache address, the second write cache address and the read cache address are each represented by a binary address.

In the embodiments provided in the disclosure, it should be understood that the disclosed system and chip may be realized in other ways. For example, the system embodiment described above is merely schematic, for example, the division of the unit is only a logical function division, which may be actually implemented, such as a plurality of units or components can be combined or integrated into another system, or some features can be ignored or not executed. Another point, the coupling or direct coupling or communication connection between each other shown or discussed may be an indirect coupling or communication connection through some interfaces, devices or units, and may be electrical, mechanical or other forms. The cells described as the separation parts may or may not be physically separate, and the components displayed as cells may or may not be physical cells, i. e. may be located in one place or distributed to a plurality of network cells. The item of the present embodiment may be realized by selecting some or all of the units according to actual needs.

1. A data scheduling system, wherein, the data scheduling system is configured to transmit data with a reconfigurable array, and the data scheduling system is configured to also transmit data with a system bus;
the data scheduling system comprises a first FIFO, a first write pointer control component, a second FIFO, a second write pointer control component, a read pointer control component, an empty-state determination control component and a full-state determination control component;
the first write pointer control component is configured to allocate a first write cache address to a processing result within the second FIFO by means of increasing an address pointer, when data to be processed is transmitted from the first FIFO to the reconfigurable array; wherein, the processing result is a result obtained by the reconfigurable array when the data to be processed is processed by the reconfigurable array, and the processing result is output by the reconfigurable array;
the second write pointer control component is configured to allocate a second write cache address within the second FIFO to a processing result currently output by the reconfigurable array by the means of increasing the address pointer, when the reconfigurable array writes the processing result into the second FIFO;
the read pointer control component is configured to allocate a read cache address to a processing result to be read within the second FIFO by the means of increasing the address pointer, when the processing result of a cache in the second FIFO is read by the system bus;
the empty-state determination control component is configured to determine an empty-state of the second FIFO according to an address value relationship between the second write cache address and the read cache address, and triggers the read pointer control component to control the second FIFO from being read data by the system bus when the second FIFO is determined to be in the empty-state, so as to control the second FIFO not being read empty;
the full-state determination control component is configured to determine a full-state of the second FIFO according to an address value relationship between the first write cache address and the read cache address, and triggers the first write pointer control component to control the first FIFO not to write data to be processed to the reconfigurable array when the second FIFO is determined to be in the full-state, so as to control the second FIFO from overflow.

2. The data scheduling system according to claim 1, wherein, the full-state determination control component is configured to determine that the second FIFO is in the full-state when it is determined that the highest bit of the first write cache address is different from the highest bit of the read cache address and the remaining bits except the highest bit in the first write cache address are equal to the remaining bits except the highest bit in the read cache address;
the empty-state determination control component is configured to determine the second FIFO is in the empty-state when it is determined that the second write cache address is the same as the read cache address;
wherein, the first write cache address, the second write cache address and the read cache address are each represented by binary addresses.

3. The data scheduling system according to claim 2, wherein, the means of increasing the address pointer performed by the first write pointer control component comprises:
when the data to be processed starts to be transmitted to the reconfigurable array from the first FIFO, the first write pointer control component is configured to output a first write pointer, and then a next write address to which the first write pointer points within the second FIFO is configured to be the first write cache address;
after the data to be processed is completely transmitted from the first FIFO to the reconfigurable array, the first write pointer control component is configured to control the first write pointer to be increased by one, then the first write pointer is updated to the first write pointer increased by one, then, when a next data to be processed starts to be transmitted to the reconfigurable array from the first FIFO, a next write address to which the updated first write pointer points within the second FIFO is updated to the first write cache address, and the next data to be processed is updated to the data to be processed, with above iterative update, until the first FIFO is in the empty-state or the second FIFO is in the full-state, so that the first write pointer has been increased by one before the processing result is transmitted to the second FIFO to reserve the address space for writing data in the second FIFO.

4. The data scheduling system according to claim 3, wherein, the means of increasing the address pointer performed by the second write pointer control component comprises:
when the reconfigurable array starts writing a processing result of a current output into the second FIFO, the second write pointer control component is configured to output a second write pointer, and then a next write address to which the second write pointer points within the second FIFO is configured to be the second write cache address;
after the processing result of the current output by the reconfigurable array is completely written into the second FIFO, the second write pointer control component is configured to control the second write pointer to be increased by one, then the second write pointer is updated to the second write pointer increased by one, and when the reconfigurable array starts writing a processing result of a next output into the second FIFO, a next write address to which the updated second write pointer points within the second FIFO is updated to the second write cache address, and the processing result of the current output is updated to the processing result of the next output.

5. The data scheduling system according to claim 4, wherein, the means of increasing the address pointer performed by the read pointer control component comprises:
when a processing result of the cache in the second FIFO starts to be read by the system bus, the read pointer control component is configured to output a read pointer, and then a next read address to which the read pointer points within the second FIFO is configured to be the read cache address;
after a current transmission processing result of the cache in the second FIFO is completely read by the system bus, the read pointer control component is configured to control the read pointer to be increased by one, then the read pointer is updated to the read pointer increased by one, and when a next processing result of the cache in the second FIFO starts to be read by the system bus, a next read address to which the updated read pointer points within the second FIFO is updated to the read cache address, and the next processing result is updated to the current transmission processing result, with above iterative update, until the second FIFO is in the empty-state;
wherein, the processing result of the current output by the reconfigurable array is the current transmission processing result.

6. The data scheduling system according to claim 4, wherein, the first write pointer control component and the second write pointer control component are each implemented by counters;
the first write pointer control component and the second write pointer control component each output their count value as a write pointer, and there is a power relationship of 2 between a bit width of the counter and a depth of the second FIFO, so that a write pointer output by the first write pointer control component and a write pointer output by the second write pointer control component each point to any cache address within the second FIFO;
wherein an address bit width corresponding to the write pointer is equal to the bit width of the counter, and the address bit width corresponding to the write pointer is a sum value obtained by adding one to an address bit width of the second FIFO;
wherein the highest bit of an address to which the write pointer points is set to a fold back flag bit for indicating whether the write pointer is incremented and over the last cache address of the second FIFO or not.

7. The data scheduling system according to claim 6, wherein, the time taken by the first write pointer control component to write the data to be processed to the reconfigurable array to the reconfigurable array to write the processing result to the second FIFO, is equal to the delay time corresponding to the flow depth of the reconfigurable array, so that the first write pointer points to the address to be written in the second FIFO for the data to be processed before the second write pointer points to the same address to be written for the processing result of the data to be processed.

8. The data scheduling system according to claim 7, wherein, the reconfigurable array comprises at least two levels cascade of computing array, the computing array of the adjacent two levels is connected as a pipeline structure that meets computing power requirements of an algorithm matching current application scenarios, by using a reconfiguration information generated by an external software configuration; wherein each level pipeline of the pipeline structure corresponds to a level computing array, and each level of the computing array comprise at least one computing unit; a delay time corresponding to the flow depth is a time consumed to data flow through the corresponding data path within the pipeline structure;
the output of the first FIFO is connected to a matching input of the reconfigurable array for receiving the data to be processed from the first FIFO and transmitting the data to be processed to a computing array on the pipeline structure for computing processing;
the input of the second FIFO is connected to a matching output of the reconfigurable array for a computing output of the pipeline structure transmitted to the second FIFO according to the reconstructed information, wherein the computing output is the processing result.

9. The data scheduling system according to claim 3, wherein, the read pointer control component is implemented by a counter;
the read pointer control component outputs their count value as a read pointer, and there is a power relationship of 2 between a bit width of the counter and a depth of the second FIFO, so that a read pointer output by the read pointer control component point to any cache address within the second FIFO;
wherein an address bit width corresponding to the read pointer is equal to the bit width of the counter, and the address bit width corresponding to the read pointer is a sum value obtained by adding an address bit width of the second FIFO to 1;
wherein the highest bit of an address to which the read pointer points is set to a fold back flag bit for indicating whether the read pointer is incremented and over the last cache address of the second FIFO or not.

10. The data scheduling system according to claim 3, wherein, the first FIFO is configured to successively receive the data to be processed from the system bus, and then store the data to be processed, and export successively the data to be processed to the reconfigurable array; when the first FIFO outputs data to be processed to the reconfigurable array, the first FIFO feeds back to the first write pointer control component to control the first write pointer to be increased by one;
the second FIFO is configured to successively receive the processing result from the reconfigurable array, and then store the processing result, and export successively the processing result to the system bus; when the second FIFO outputs a processing result to the system bus, the second FIFO feeds back to the second write pointer control component to control the second write pointer to be increased by one;
wherein the second FIFO and the first FIFO are each set to synchronous FIFO.

11. A reconfigurable processor, wherein, integrates the reconfigurable array and the data scheduling system of claim 1.

12. A data scheduling method, wherein, data transmission with a reconfigurable array is arranged by means of a data scheduling system, and data transmission with a bus system is arranged by means of a data scheduling system; wherein the data scheduling system comprises a first FIFO and a second FIFO;
The data scheduling method comprises:
Step A, when data to be processed is transmitted from the first FIFO to the reconfigurable array, pre-allocating the first write cache address within the second FIFO to a processing result, then controlling the first write cache address to be increased by one and to be updated; wherein the processing result is a result obtained by the reconfigurable array when the data to be processed is processed by the reconfigurable array, and the processing result is output by the reconfigurable array;
Step B, when the second FIFO receives a processing result currently output by the reconfigurable array, allocating the second write cache address within the second FIFO to the processing result currently output by the reconfigurable array, then controlling the second write cache address to be increased by one and being updated;
Step C, when the processing result of a cache in the second FIFO is read by the system bus, allocating a read cache address to a processing result to be read within the second FIFO, then controlling the read cache address to be increased by one and to be updated;
Step D, determining an empty-state of the second FIFO according to an address value relationship between the second write cache address and the read cache address, and when the second FIFO is in an empty-state, controlling the second FIFO from being read data by the system bus, so as to control the second FIFO not being read empty;
Step E, determining a full-state of the second FIFO according to an address value relationship between the first write cache address and the read cache address, and when the second FIFO is in the full-state, controlling the first FIFO not to write data to be processed to the reconfigurable array, so that the second FIFO does not overflow.

13. The data scheduling method according to claim 12, wherein, when it is determined that the highest bit address value of the first write cache address is different from the highest bit of the read cache address, and the remaining bits except the highest bit in the first write cache address are equal to the remaining bits except the highest bit in the read cache address, the second FIFO is in the full-state;
when it is determined that the second write cache address is the same as the read cache address, the second FIFO is in the empty-state;
wherein, the first write cache address, the second write cache address and the read cache address are each represented by a binary address.

14. The data scheduling method according to claim 13, wherein, the specific method of the step A comprises:
Step A1, when the data to be processed starts to be transmitted to the reconfigurable array from the first FIFO, the data scheduling system generates the first write pointer, and then a next write address to which the first write pointer points within the second FIFO is configured to be the first write cache address; and then executing step A2;
Step A2, after the data to be processed is completely transmitted from the first FIFO to the reconfigurable array, controlling the first write pointer to be increased by one, and then the first write pointer is updated to the first write pointer increased by one, and then executing step A3;
Step A3, when a transmission of a next data to be processed to the reconfigurable array starts from the first FIFO, a next write address to which the first write pointer updated in step A2 points within the second FIFO is updated to the first write cache address, and then the next data to be processed is updated to the data to be processed, then return to step A2, then step A2 and step A3 are executed iteratively until the first FIFO is in the empty-state or the second FIFO is in the full-state, so that the first write pointer has been increased by one before the processing result is transmitted to the second FIFO to reserve the address space for writing data in the second FIFO.

15. The data scheduling method according to claim 14, wherein, the specific method of the step B comprises:
Step B1, the reconfigurable array starts writing a processing result of a current output into the second FIFO, the second write pointer is generated, and then a next write address to which the second write pointer points within the second FIFO is configured to be the second write cache address; and then executing step B2;
Step B2, after the processing result of the current output by the reconfigurable array is completely written into the second FIFO, controlling the second write pointer to be increased by one, and then updating the first write pointer increased by one to the first write pointer, then executing to step B3;
Step B3, when the reconfigurable array starts writing a processing result of a next output into the second FIFO, a next write address to which the second write pointer updated in step B2 points within the second FIFO is updated to the second write cache address, and then the processing result of the current output is updated to the processing result of the next output, and then returns to step B2.

16. The data scheduling method according to claim 15, wherein, the specific method of the step C comprises:
Step C1, when a processing result of the cache in the second FIFO is read by the system bus, a read pointer is generated, and then a next read address to which the read pointer points within the second FIFO is configured to be the read cache address; and then executing step C2;
Step C2, when a processing result of the cache in the second FIFO is completely read by the system bus, controlling the read pointer to be increased by one, and then updating the read pointer increased by one to the read pointer, then executing to step C3;
Step C3, when a next processing result of the cache in the second FIFO starts to be read by the system bus, a next read address to which the updated read pointer points within the second FIFO is updated to the read cache address, then returning to step C2, then the step C2 and the step C3 are executed iteratively until the second FIFO is in the empty-state.
